(19) United States
(12) Patent Application Publication
(10) Pub. No.: US 2002/0116365 A1
(43) Pub. Date: Aug. 22, 2002

(54) System and method for classifying tangible assets

(75) Inventor: David W. Kusin, Dallas, TX (US)

Correspondence Address: JACKSON WALKER LLP, 112 E. Pecan, Suite 2100, San Antonio, TX, 78205-3731, US

(73) Assignee: A SYSTEM AND METHOD FOR CLASSIFYING TANGIBLE ASSETS

(21) Appl. No.: 10/047,563

(22) Filed: Jan. 14, 2002

Related U.S. Application Data
(60) Provisional application No. 60/261,385, filed on Jan. 12, 2001.

(51) Int. Cl. G06F 7/00

(52) U.S. Cl. 707/1

(57) ABSTRACT

A method for classifying tangible art objects using a classification code such that the value of a given asset may be readily determined. The basic steps of the classification method of the present invention include providing a database for storage of information regarding a given asset, establishing within the database one or more order categories, identifying each order category with a first identifier, determining which order categories describes the given asset, designating the given asset as being classified by the order category which best describes the given asset in the database, and assigning the applicable first identifier to the given asset.

One or more family categories may then be established such that the given asset may be further classified. Once family categories have been established, each family category is identified with a second identifier. It is then determined, based upon the stored information concerning the given asset, what family category describes the given asset. Once the applicable family category is determined, the given asset is designated as being described by the applicable family category. The second identifier corresponding to the applicable family category may then be assigned to the given asset and the first and second identifiers may be combined to define an identifier code.

One or more genus categories may then be established such that the given asset may be further classified. Once genus categories have been established, each genus category is identified with a third identifier. It is then determined, based upon the stored information concerning the given asset, what genus category describes the given asset. Once the applicable genus category is determined, the given asset is designated as being described by the applicable genus category. The third identifier corresponding to the applicable genus category may then be assigned to the given asset and the first, second and third identifiers may be combined to further define the identifier code.

One or more species categories may then be established such that the given asset may be further classified. Once species categories have been established, each species category is identified with a fourth identifier. It is then determined, based upon the stored information concerning the given asset, what species category describes the given asset. Once the applicable species category is determined, the given asset is designated as being described by the applicable species category. The fourth identifier corresponding to the applicable species category may then be assigned to the given asset and the first, second, third, and fourth identifiers may be combined to further define the identifier code.

One or more sub-species categories may then be established such that the given asset may be further classified. Once sub-species categories have been established, each sub-species category is identified with a fifth identifier. It is then determined, based upon the stored information concerning the given asset, what sub-species category describes the given asset. Once the applicable sub-species category is determined, the given asset is designated as being described by the applicable sub-species category. The fifth identifier corresponding to the applicable sub-species category may then be assigned to the given asset and the first, second, third, fourth and fifth identifiers may be combined to further define the identifier code.

Patent application claims priority from a provisional application entitled “A SYSTEM AND METHOD FOR CLASSIFYING TANGIBLE ASSETS,” Ser. No. 60/261,385, having a filing date of Jan. 12, 2001.

### COPYRIGHT NOTICE

The classification code of the present invention, included as part of the specification, contains material which is subject to copyright protection. The copyright owner has no objection to the facsimile reproduction of this material as it appears in the United States Patent and Trademark patent files or records, but otherwise reserves all copyright rights whatsoever.

### BACKGROUND OF THE INVENTION

The present invention relates generally to a classification system and more particularly to a classification code for classifying tangible art objects.

Classification systems such as the Dewey Decimal System and the Library of Congress classification system have been in existence for some time. To classify each item, each work is divided into separate categories and assigned an alpha-numeric identifier. This allows each work to be shelved in a predetermined location such that the status of each work may be readily determined.

Other products have classified an item so that it may be compared to similar items such that its value may be estimated. Products such as the Kelly Blue Book have been used to assess the value of mass produced items, such as automobiles, using input data such as model year, body condition, and mileage.

The prior art has attempted to apply the above methodologies to tangible assets such as art objects, but with little economic or statistical success. The materials, method of construction, authenticity, condition, and provenance seen in an original, one-of-a-kind art object cannot be valued with a reasonable degree of certainty with non-subjective factors alone. Art objects rely to a greater extent upon subjective assessment by scholars, critics, connoisseurs, and curators such that a valuation of an art object must take into account not only current subjective data but also data that spans years into the past.

The classification code of the present invention allows for the classification of art objects in a manner that provides stability to the valuation process and to economic and statistical consistency. The present invention is designed to classify art objects using a comprehensive asset class structure premised on curatorial and operational requirements.

### SUMMARY OF THE INVENTION

Accordingly, the present invention is a new and innovative manner of classifying tangible assets that can, in addition, provide access to a plurality of independently moving market trajectories within the art economy. The present invention provides a definitive reporting standard for measuring and tracking the marketplace performance of fine art, decorative art, antiquities, other discrete disciplines, and collectibles. This allows collectors, dealers, auctioneers, bankers, asset managers, and legal advisors to manage and track the value and cross-generational transfer of art objects.

The asset is classified using a unique classification code which divides tangible art objects such as fine art, decorative art, antiquities, other discrete disciplines, and collectibles into order, family, genus, species, and sub-species categories. This classification may then be cross-referenced with relevant auction house data, including art objects that were offered for sale but failed to find buyers, to help determine fair market value. Relevant data may be weighted for risk against pre-sale estimates and venue performance as well as discounted to diminish the past effects of extreme or irrational behavior on the part of buyers on the auction floor.

The classification code of the present invention allows tangible art objects to be classified into the above categories and assigned a series of identifiers such that the asset may be cross referenced with relevant data to track worldwide market performance of specific types of categorized assets. Historic market performance patterns may be graphed and cross-referenced to well known standards such as the Consumer Price Index (CPI) and the Standard & Poor's 500 (S&P 500), among others, to ensure statistical reliability.

By providing a uniform and statistically sound method of classifying art objects, the present invention not only provides financial institutions with the consistent taxonomy they require for conducting rigorous risk analysis for lending purposes, it also provides a standard nomenclature for classifying art objects. Specifically, the present invention allows the value of an art object to be determined with greater accuracy such that lenders may set advance rates more precisely, thus decreasing risk to financial intermediaries.

### BRIEF DESCRIPTION OF THE DRAWINGS

FIG. 1 illustrates an embodiment of the present invention utilizing a computer system.

FIG. 2 illustrates the classification code of the present invention.

FIG. 3 illustrates an embodiment of the present invention utilizing a computer readable medium.

FIG. 4 is a flowchart illustrating an embodiment of the tangible asset classification process of the present invention.

### DETAILED DESCRIPTION OF THE PREFERRED EMBODIMENT

The present invention is herein described as a classification code (100) that can be used to access and sort asset data, thus allowing a computer system to classify tangible assets, a computer readable medium comprising a plurality of instructions for classifying tangible assets, and as a method for classifying tangible assets, as shown in the Figures.

### Computer System

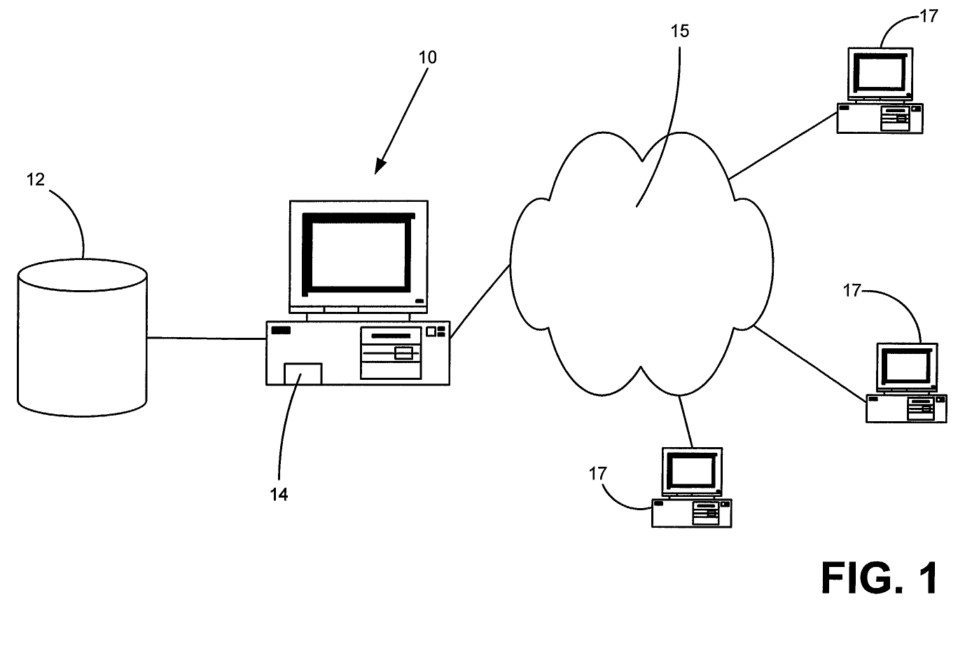

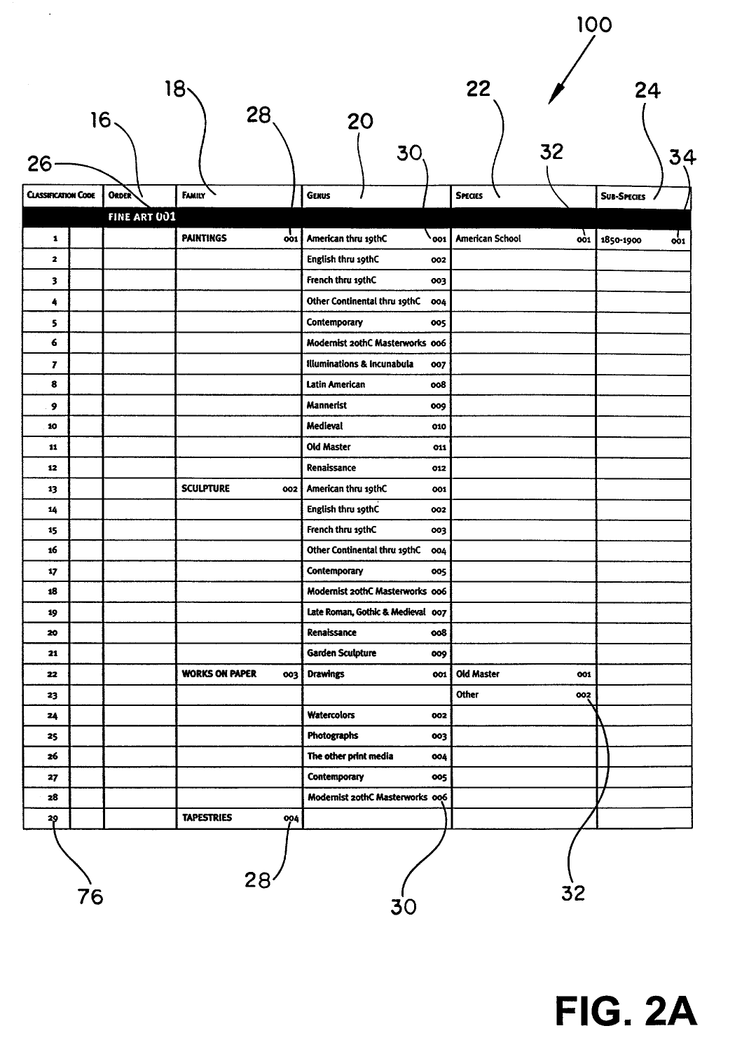

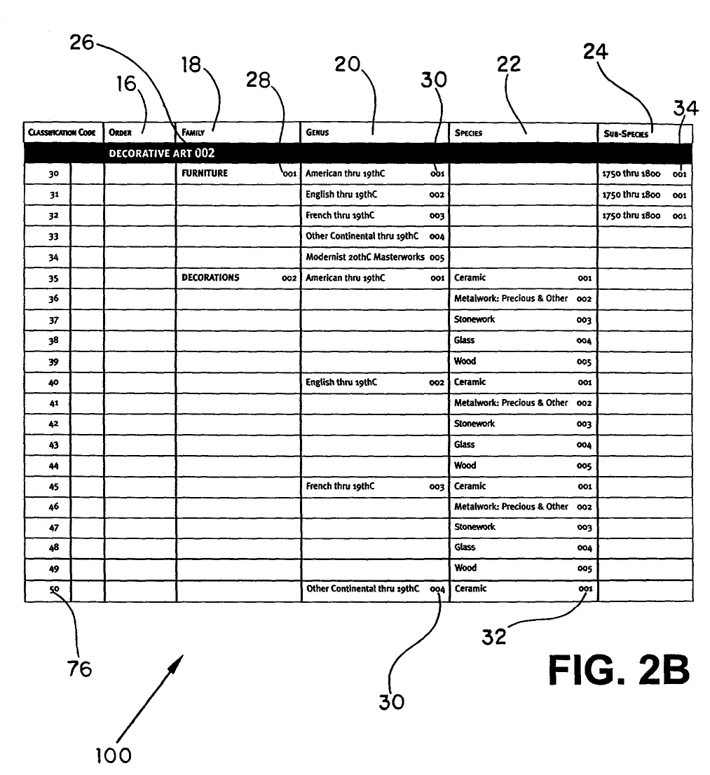

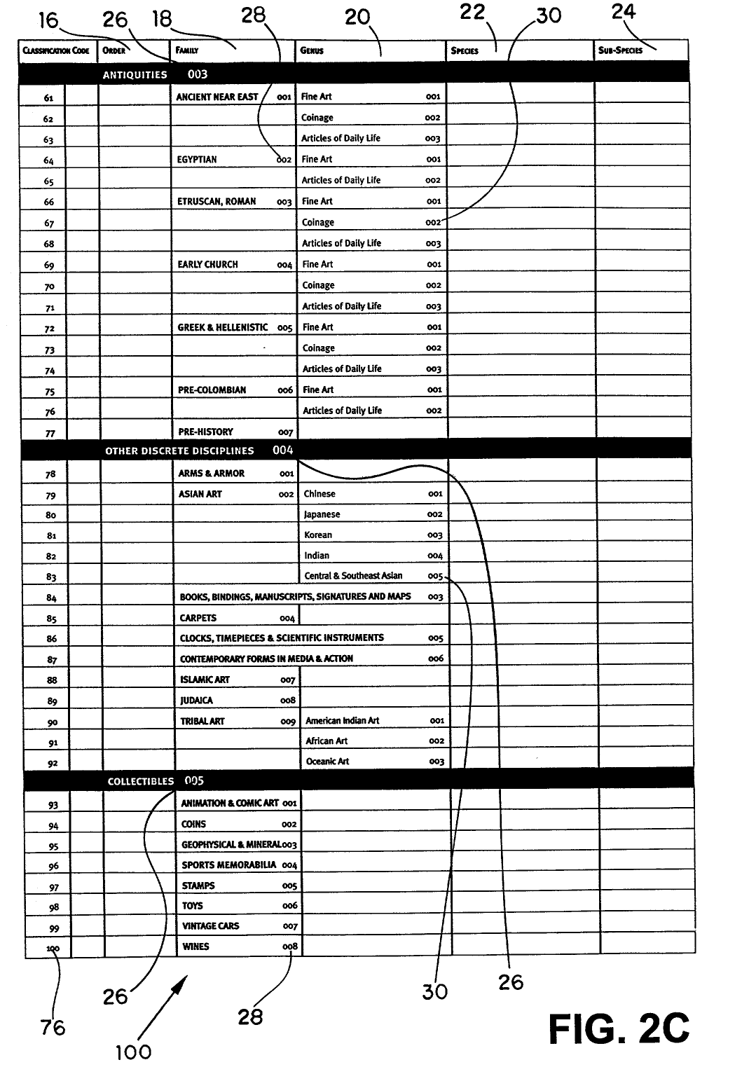

Referring to FIGS. 1 and 2, the classification of tangible assets may be instituted by any suitable electronic device such as a computer system (10). In one embodiment, the computer system of the present invention has at least one database (12) for storing information for each given asset and for storing information concerning each category of assets. The term “database” is used throughout this document to describe anything used to collect and/or organize data. This includes, but is not limited to, a computer, card catalog, hard copy file, electronic file, email storage device, and/or electronic memory device. In one embodiment, the database (12) is an electronic device searchable by a processing unit (14) coupled to the database (12).

The processing unit (14) is capable of establishing each category of the classification system of the present invention. These categories include order (16), family (18), genus (20), species (22), and sub-species (24) groups. The present invention is especially useful for classifying art objects. The present invention allows the value of a given art object to be evaluated using stored information describing other assets of the same identifier code, as described below. The present invention establishes a consistent framework to allow data to be sorted and compiled so that lenders may assess the risk of an art object and set advance rates more precisely, thus decreasing risk and enhancing asset value.

Referring to FIGS. 1 and 2, once the categories are established, the processing unit (14) identifies each category with an identifier. Specifically, a first identifier (26) is used for each order category (16), a second identifier (28) is used for each family category (18), a third identifier (30) is used for each genus category (20), a fourth identifier (32) is used for each species category (22), and a fifth category (34) is used for each sub-species category (24). These identifiers may be letters, numbers, or any other textual or graphical information. Once a given asset is classified into each category, the first, second, third, fourth, and fifth identifiers (26, 28, 30, 32 and 34, respectively) are combined to form an identifier code, as described below. This provides a common reference such that information gathered for assets having the same identifier code may be quickly and easily compared with the given asset.

Once the categories have been established and identifiers have been assigned, the processing unit (14) is capable of analyzing input data concerning a given asset so that it may determine which categories apply to the given asset. When this is determined, the given asset is designated as having a specific order, family, genus, species, and subspecies category (16, 18, 20, 22 and 24, respectively). The applicable first, second, third, fourth, and fifth identifiers (26, 28, 30, 32 and 34, respectively) are then assigned to the given asset.

This information may be sent to the database (12) for storage, and/or used to conduct comparisons between the given asset and other assets having the same identifier code. This is done using valuation information stored in the database (12) to determine the market risk of the given asset. Valuation information may be entered into the computer system (10) using an input device (not shown) such as a mouse or keyboard. Asset information may be transmitted through local or wide area networks or the internet so that it may be readily available anywhere.

### Computer Readable Medium

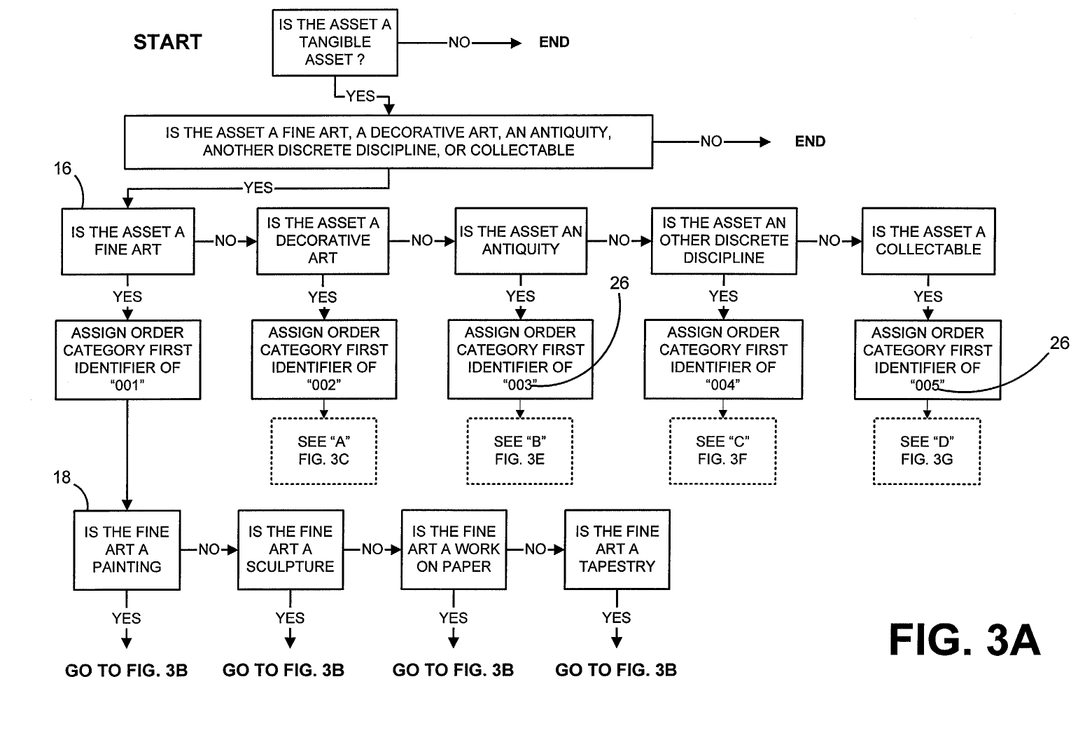

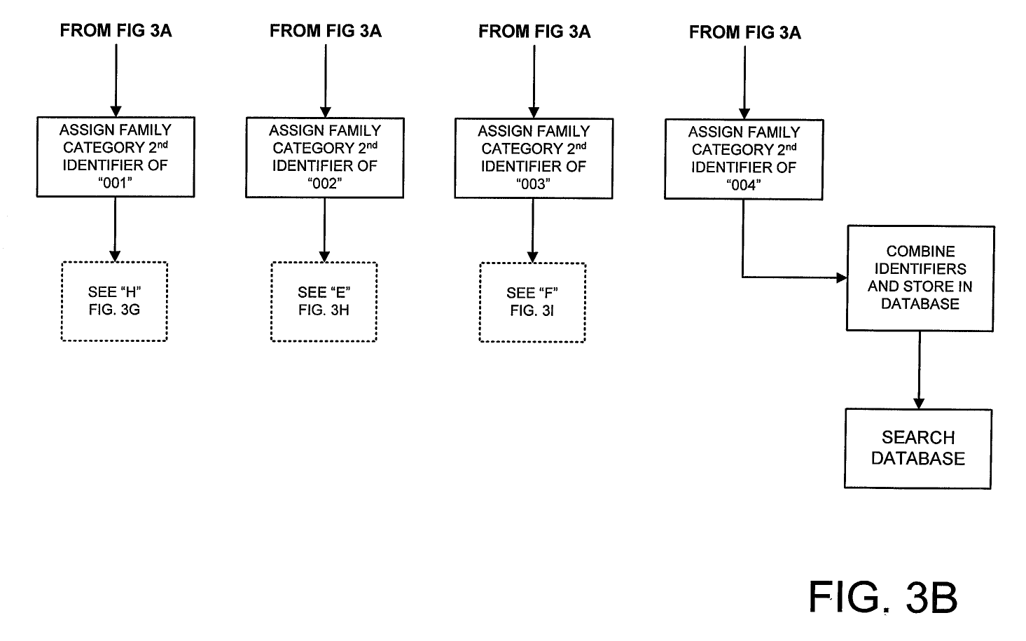

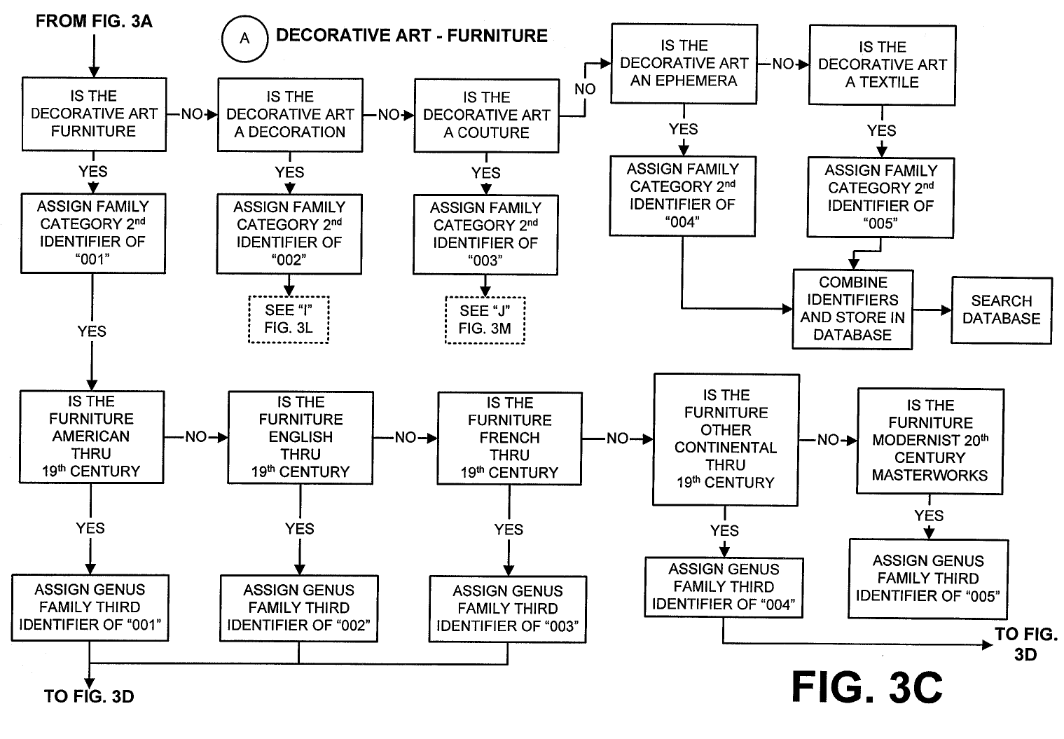

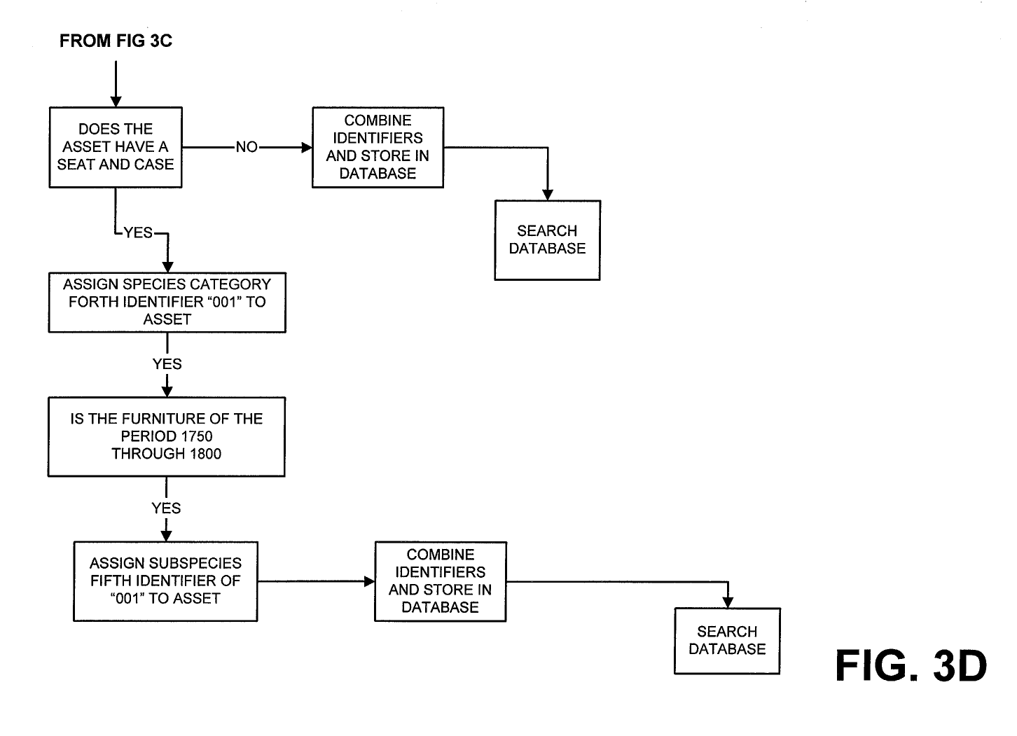

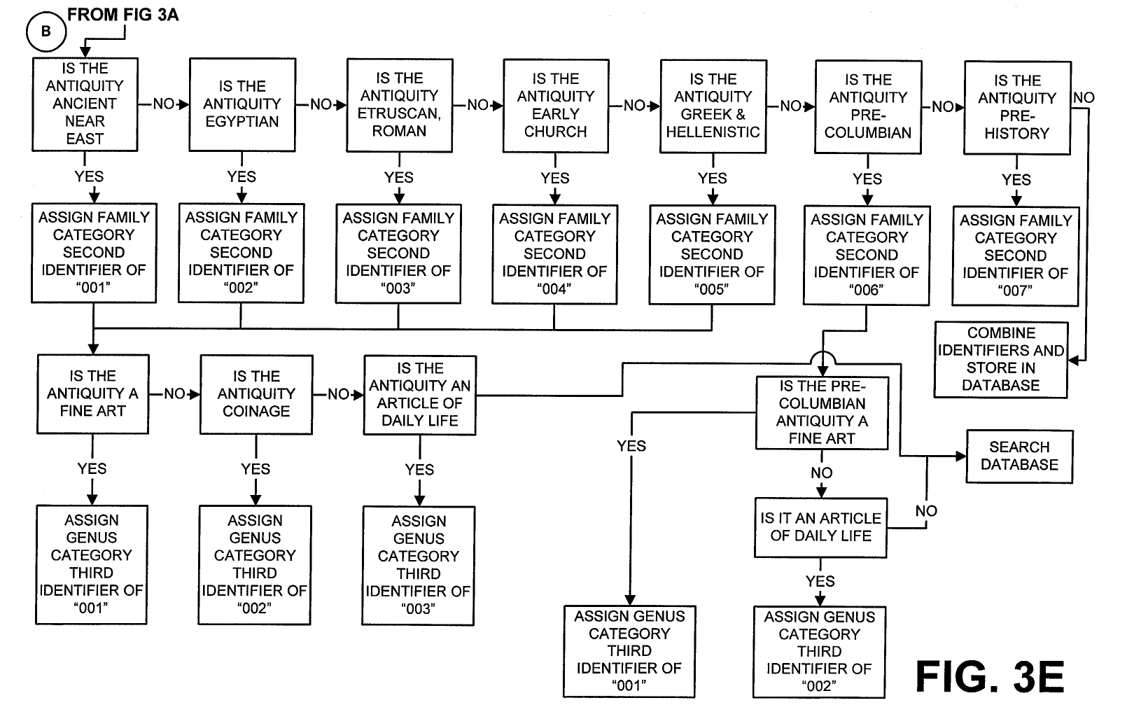

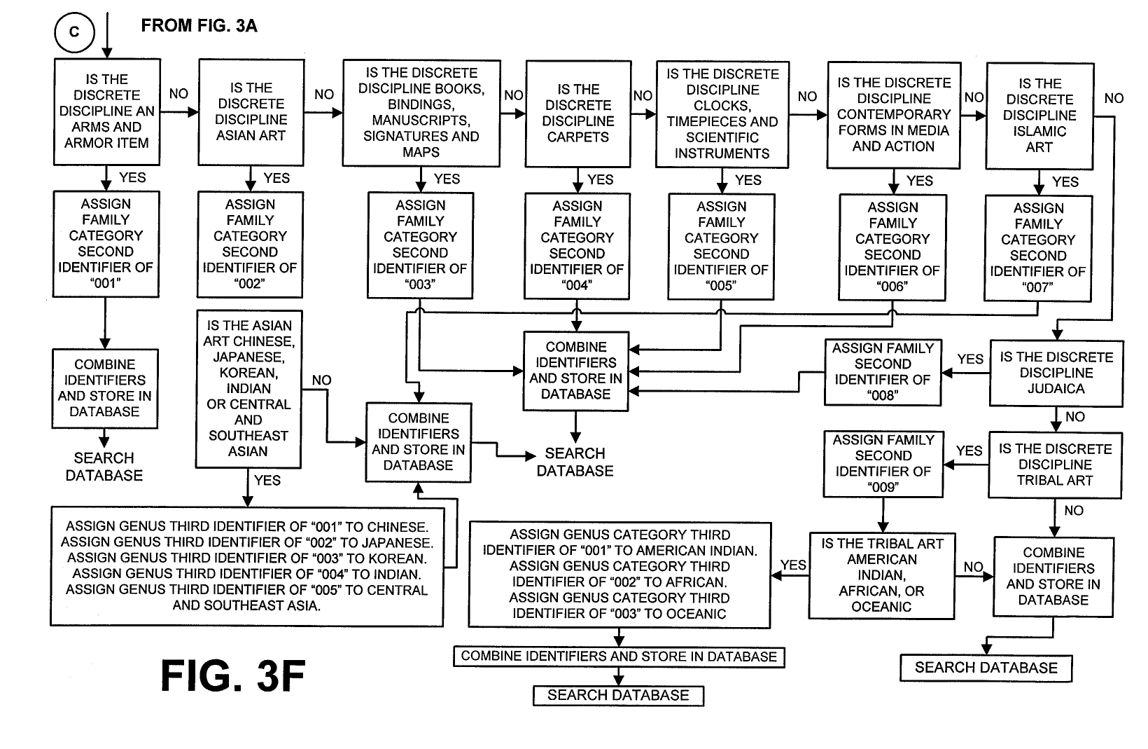

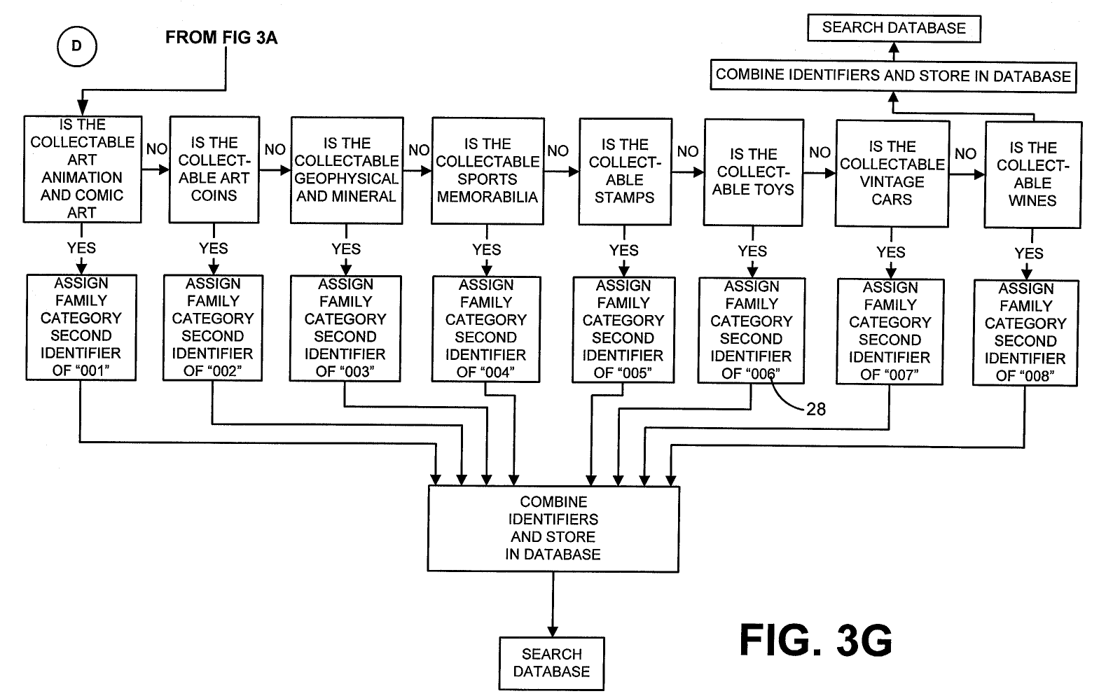

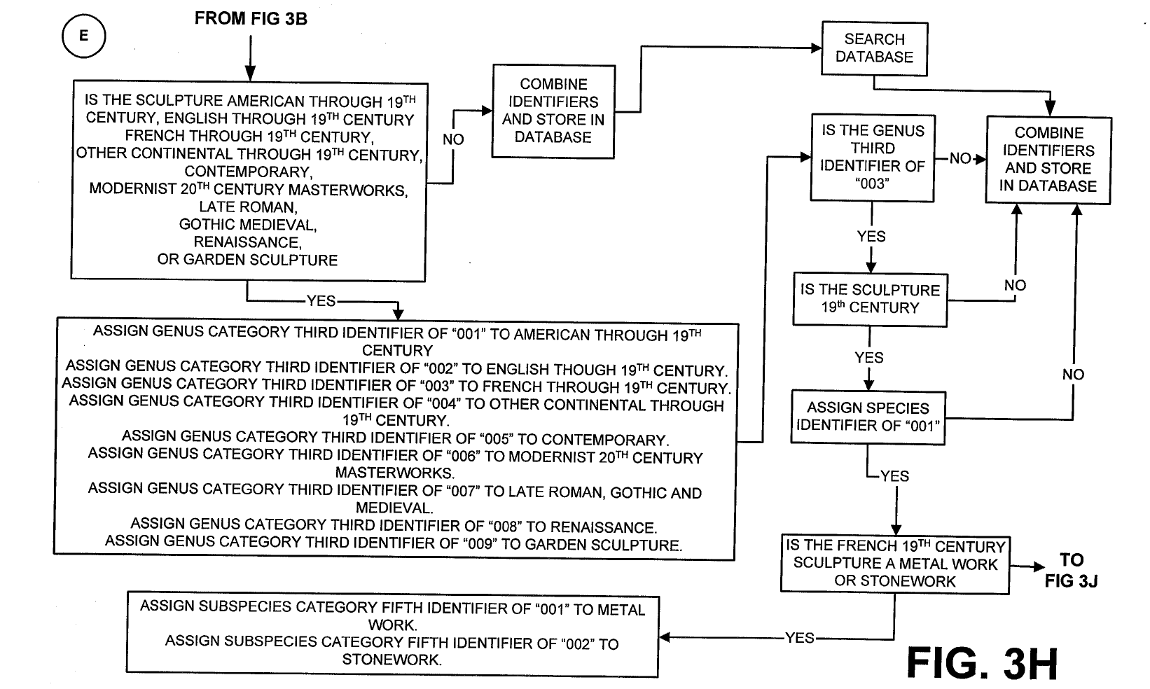

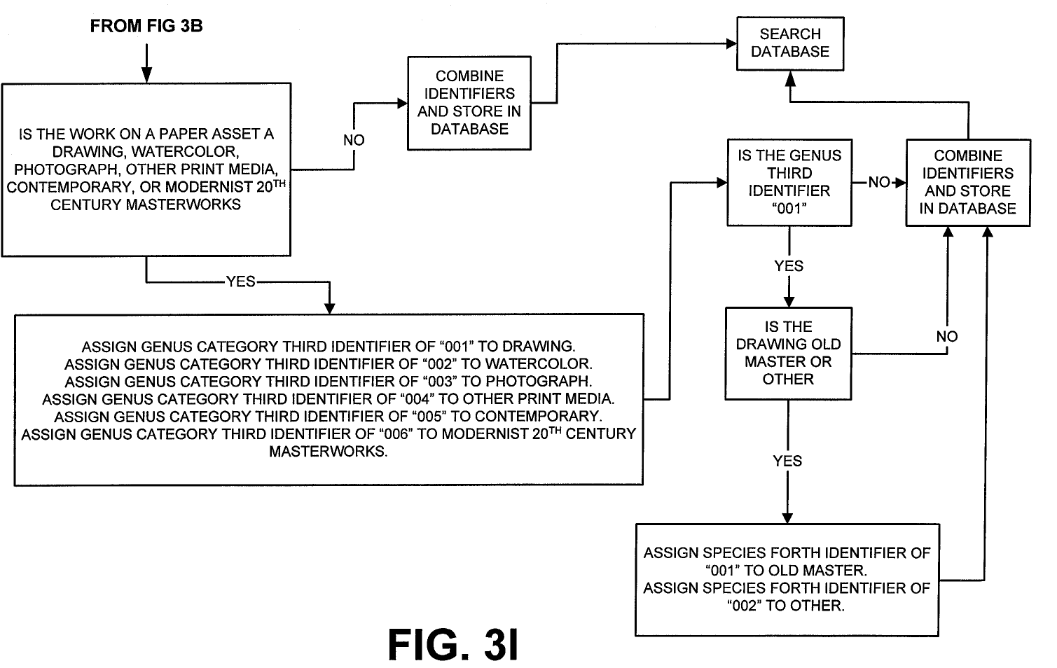

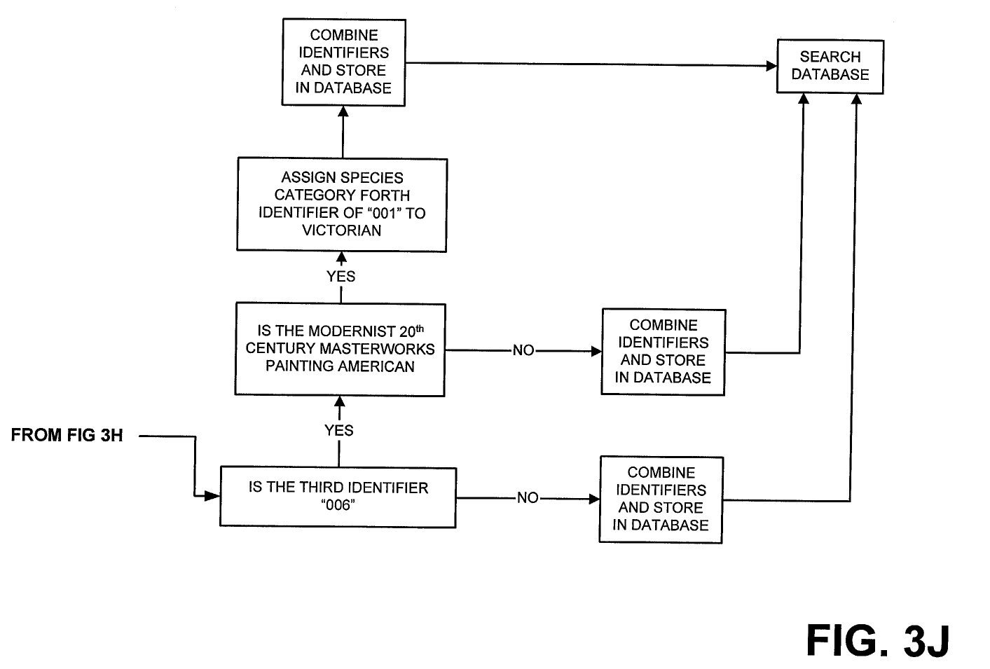

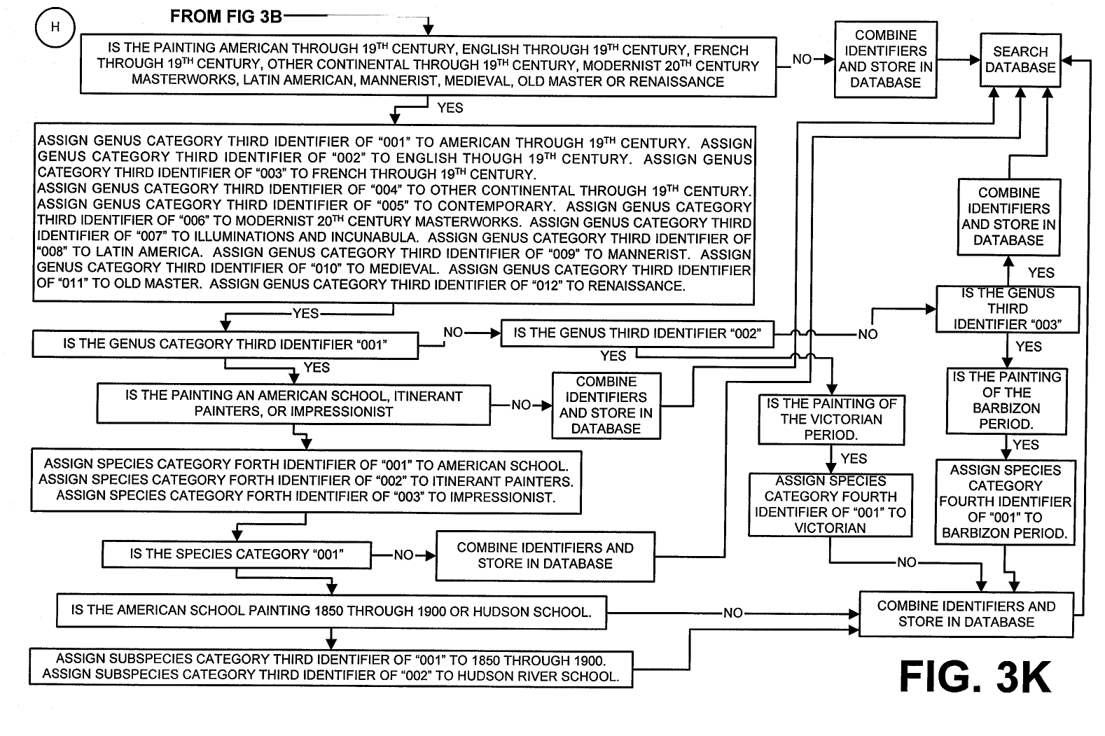

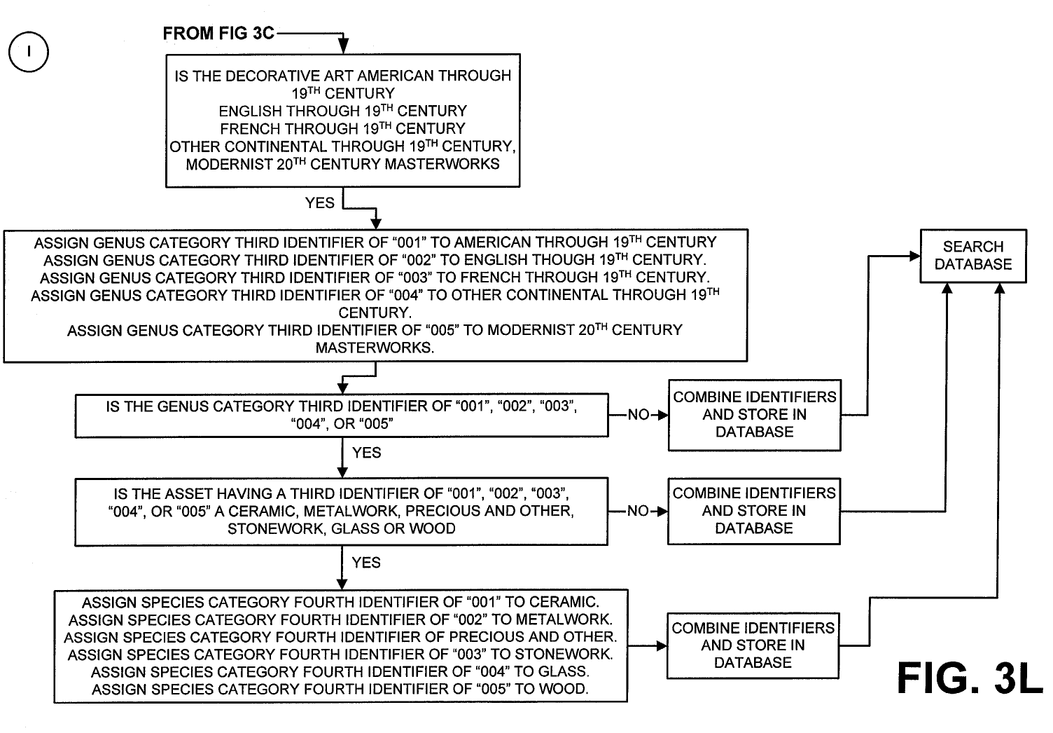

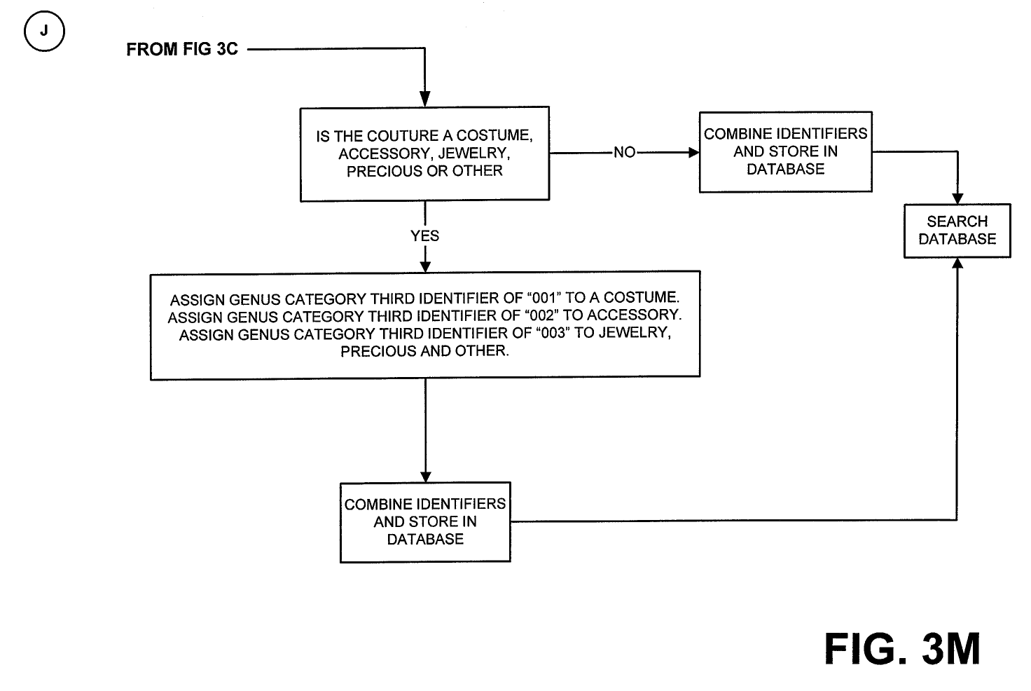

Referring to FIGS. 2 and 3, the present invention may also be described as a computer readable medium (150) that uses a plurality of instructions used to classify tangible assets. These instructions are read by an electronic device, such as a computer, such that they cause the computer to perform various classification steps.

### Order Categories

First, the computer (10) is instructed to receive information concerning a given asset. This information may then be stored in a database (12) that is coupled to the computer. The term “database” is used throughout this document to describe anything used to collect and/or organize data. This includes, but is not limited to, a computer, card catalog, hard copy file, electronic file, email storage device, and/or electronic memory devices. In one embodiment, the database (12) is an electronic device used in conjunction with a computer.

Second, the computer is instructed to establish one or more order categories (16) for use in broadly classifying the given asset. Third, the computer (10) is instructed to identify each order category (16) with a first identifier (26). Fourth, the computer (10) is instructed to determine, based upon the stored information concerning the given asset, what order category (16) describes the given asset. In one embodiment, four order categories (16) are established by the computer (10) at the instruction of the computer readable medium (150). Once the applicable order category (16) is determined, the computer (10) is instructed to designate the given asset as being described by the applicable order category (16) and a first identifier (26) corresponding to the applicable order category is assigned to the given asset, as described below.

In one embodiment of the present invention, the order categories are Fine Art, Decorative Art, Antiquities, Other Discrete Disciplines, and Collectibles. In this embodiment, “001” is used as the first identifier for the Fine Art order category, “002” is used as the first identifier for the Decorative Art category, “003” is used as the first identifier for the Antiquities category, “004” is used as the first identifier for the Other Discrete Disciplines category, and “005” is used as the first identifier for the Collectibles category.

### Family Categories

The computer (10) may then be instructed to establish one or more family categories (18) for use in further classifying the given asset. Once Family categories have been established, the computer (10) is instructed to identify each family category (18) with a second identifier (28). The computer (10) is then instructed to determine, based upon the stored information concerning the given asset, what family category describes the given asset. Once the applicable family category (18) is determined, the computer (10) is instructed to designate the given asset as being described by the applicable family category and the second identifier (28) corresponding to the applicable family category is assigned to the given asset.

In one embodiment, the Fine Art order category includes four family categories each having a second identifier. In one embodiment, these categories include Paintings having a second identifier of “001”, Sculpture “002”, Works on Paper “003”, and Tapestries “004”. To illustrate, the identifier code of a given asset determined to have a Fine Art order category and a Tapestries family category would be designated by first and second identifiers of “001.004”.

In one embodiment, the Decorative Art order category includes five family categories each having a second identifier. These categories include Furniture “001”, Decorations “002”, Couture “003”, Ephemera “004”, and Textiles “005”. To illustrate, the identifier code of a given asset determined to have a Decorative Art order category and a Textiles family category would be designated by “002.005”.

In one embodiment, the Antiquities order category includes seven family categories each having a second identifier. These categories include Ancient Near East “001”, Egyptian “002”, Etruscan, Roman “003”, Early Church “004”, Greek & Hellenistic “005”, Pre-Columbian “006”, and Pre-History “007”. To illustrate, the identifier code of a given asset determined to have an Antiquities order category and an Egyptian family category would be designated by “003.002”.

In one embodiment, the Other Discrete Disciplines order category includes nine family categories each having a second identifier. These categories include Arms & Armor “001”, Asian Art “002”, Books, Bindings, Manuscripts, Signatures, & Maps “003”, Carpets “004”, Clocks, Timepieces and Scientific Instruments “005”, Contemporary Forms in Media & Action “006”, Islamic Art “007”, Judaica “008”, and Tribal Art “009”. To illustrate, the identifier code of a given asset determined to have an Other Discrete Disciplines order category and a Carpets family category would be designated by “004.004”.

In one embodiment, the Collectibles order category includes eight family categories each having a second identifier. These categories include Animation & Comic Art “001”, Coins “002”, Geophysical & Mineral “003”, Sports Memorabilia “004”, Stamps“005”, Toys “006”, and Vintage Cars “007”, and Wines “008”. To illustrate, the identifier code of a given asset determined to have a Collectibles order category and a Wines family category would be designated by “005.008”.

### Genus Categories

The computer (10) may then be instructed to establish one or more genus categories (20) for use in further classifying the given asset. Once genus categories have been established, the computer (10) is instructed to identify each genus category (20) with a third identifier (30). The computer (10) is then instructed to determine, based upon the stored information concerning the given asset, what genus category (20) describes the given asset. Once the applicable genus category is determined, the computer (10) is instructed to designate the given asset as being described by the applicable genus category (20) and the third identifier (30) corresponding to the applicable genus category is assigned to the given asset.

In one embodiment, the Paintings family category includes twelve genus categories each having a third identifier. These categories include American through 19^{th} century “001”, English through 19^{th} century “002”, French through 19^{th} century “003”, Other Continental through 19^{th} century “004”, Contemporary “005”, Modernist 20^{th} Century Masterworks “006”, Illuminations & Incunabula “007”, Latin America “008”, Mannerist “009”, Medieval “010”, Old Master “011”, and Renaissance “012”. To illustrate, the identifier code of a given asset determined to have a Fine Art order category, a Paintings family category, and a Mannerist genus category would be designated by “001.001.009”.

In one embodiment, the Sculpture family category includes nine genus categories each having a third identifier. These categories include American through 19^{th} century “001”, English through 19^{th} century “002”, French through 19^{th} century “003”, Other Continental through 19^{th} century “004”, Contemporary “005”, Modernist 20^{th} century Masterworks “006”, Late Roman, Gothic & Medieval “007”, Renaissance “008”, and Garden Sculpture “009”. To illustrate, the identifier code of a given asset determined to have a Fine Art order category, a Sculpture family category, and a Garden Sculpture genus category would be designated by “001.002.009”.

In one embodiment, the Works on Paper family category includes six genus categories each having a third identifier. These categories include Drawings “001”, Watercolors “002”, Photographs “003”, The Other Print Media “004”, Contemporary “005”, and Modernist 20^{th} century Masterworks “006”. To illustrate, the identifier code of a given asset determined to have a Fine Art order category, a Works on Paper family category, and a photographs genus category would be designated by first, second, and third identifiers of “001.003.003”.

In one embodiment, the Furniture family category within the Decorative Art order category includes five genus categories each having a third identifier. These categories include American through 19^{th} century “001”, English through 19^{th} century “002”, French through 19^{th} century “003”, Other Continental through 19^{th} century “004”, and Modernist 20^{th} century Masterworks “005”. To illustrate, the identifier code of a given asset determined to have a Decorative art order category, a Furniture family category, and a Other Continental through 19^{th} century genus category would be designated by “002.001.004”.

In one embodiment, the Decorations family category within the Decorative Art order category includes five genus categories each having a third identifier. These categories include American through 19^{th} century “001”, English through 19^{th} century “002”, French through 19^{th} century “003”, Other Continental through 19^{th} century “004”, and Modernist 20^{th} century Masterworks “005”. To illustrate, the identifier code of a given asset determined to have a Decorative art order category, a Decorations family category, and a Other Continental through 19^{th} century genus category would be designated by “002.002.004”.

In one embodiment, the Couture family category within the Decorative Art order category includes three genus categories each having a third identifier. These categories include Costumes “001”, Accessories “002”, and Jewelry: Precious and Other “003”. To illustrate, the identifier code of a given asset determined to have a Decorative Art order category, a Couture family category, and a Costumes genus category would be designated by “002.003.001”.

In one embodiment, the Ancient Near East, Egyptian, Etruscan/Roman, Early Church or Greek & Hellenistic family categories within the Antiquities order category include three genus categories each having a third identifier. These categories include Fine Art “001”, Coinage “002”, and Articles of Daily Life “003”. To illustrate, the identifier code of a given asset determined to have an Antiquities order category, an Egyptian family category, and a Fine Art genus category would be designated by “003.002.001”.

In one embodiment, the Pre-Columbian family category within the Antiquities order category include two genus categories each having a third identifier. These categories include Fine Art “001” and Articles of Daily Life “002”. To illustrate, the identifier code of a given asset determined to have an Antiquities order category, a Pre-Columbian family category, and a Fine Art genus category would be designated by “003.006.001”.

In one embodiment, the Asian Art family category within the Other Discrete Disciplines order category includes five genus categories each having a third identifier. These categories include Chinese “001”, Japanese “002”, Korean “003”, Indian “004”, and Central & Southeast Asian “005”. To illustrate, the identifier code of a given asset determined to have a Decorative Art order category, a Couture family category, and a Costumes genus category would be designated by “002.003.001”.

In one embodiment, the Tribal Art family category within the Other Discrete Disciplines order category includes three genus categories each having a third identifier. These categories include American Indian Art “001”, African Art “002”, and Oceanic Art “003”. To illustrate, the identifier code of a given asset determined to have an Other Discrete Disciplines order category, a Tribal Art family category, and an African Art genus category would be designated by “004.008.002”.

### Species Categories

The computer may then be instructed to establish one or more species categories (22) for use in further classifying the given asset. Once Species categories (22) have been established, the computer (10) is instructed to identify each Species category with a fourth identifier (32). The computer (10) is then instructed to determine, based upon the stored information concerning the given asset, what Species category (22) describes the given asset. Once the applicable Species category is determined, the computer (10) is instructed to designate the given asset as being described by the applicable Species category (22) and the fourth identifier (32) corresponding to the applicable Species category (22) is assigned to the given asset.

Referring further to FIG. 2, in one embodiment, the American through 19^{th} century genus category having a Paintings family category includes three species categories each having a fourth identifier. These categories include American School “001”, Itinerant Painters “002”, and Impressionists “003”. To illustrate, the identifier code of a given asset determined to have a Fine Art order category, a Paintings family category, an American through 19^{th} century genus category, and an American School species category would be designated by “001.001.001.001”.

In one embodiment, the English through 19^{th} century genus category having a Paintings family category includes one species category having a fourth identifier. This category includes Victorian “001”. To illustrate, the identifier code of a given asset determined to have a Fine Art order category, a Paintings family category, an English through 19^{th} century genus category, and a Victorian species category would be designated by “001.001.002.001”.

In one embodiment, the French through 19^{th} century genus category having a Paintings family category includes two species categories each having a fourth identifier. These categories include Barbizon School “001” and Impressionists “002”. To illustrate, the identifier code of a given asset determined to have a Fine Art order category, a Paintings family category, a French through 19^{th} century genus category, and an Impressionists species category would be designated by “001.001.003.002”.

In one embodiment, the Modernist 20^{th} century Masterworks genus category having a Paintings family category includes one species category having a fourth identifier. This category includes American “001”. To illustrate, the identifier code of a given asset determined to have a Fine Art order category, a Paintings family category, a Modernist 20^{th} century Masterworks genus category, and an American species category would be designated by “001.001.006.001”.

In one embodiment, the French through 19^{th} century genus category having a Sculpture family category includes one species category having a fourth identifier. This category includes 19^{th} Century “001”. To illustrate, the identifier code of a given asset determined to have a Fine Art order category, a Sculpture family category, a French through 19^{th} century genus category, and a 19^{th} century species category would be designated by “001.002.003.001”.

In one embodiment, the Drawings genus category having a Works on Paper family category includes two species categories each having a fourth identifier. These categories include Old Master “001” and Other “002”. To illustrate, the identifier code of a given asset determined to have a Fine Art order category, a Works on Paper family category, Drawings genus category, and an Old Master species category would be designated by “001.003.001.001”.

In one embodiment, the American through 19^{th} century, English through 19^{th} century, and French through 19^{th} century genus categories located within the Furniture family category each include one species category having a fourth identifier. This category includes Seat & Case “001”. To illustrate, the identifier code of a given asset determined to have a Decorative Art order category, a Furniture family category, an American through 19^{th} century genus category, and a Seat & Case species category would be designated by “002.001.001.001”.

In one embodiment, the American through 19^{th} century, English through 19^{th} century, French through 19^{th} century, and Other Continental through 19^{th} century genus categories located within the Decorations family category each include five species categories each having a fourth identifier. These categories include Ceramic “001”, Metalwork: Precious & Other “002”, Stonework “003”, Glass “004” and Wood “005”. To illustrate, the identifier code of a given asset determined to have a Decorative Art order category, a Decorations family category, an American through 19^{th} century genus category, and a Wood species category would be designated by “002.002.001.005”.

### Sub-Species Categories

The computer (10) may then be instructed to establish one or more sub-species categories (24) for use in further classifying the given asset. Once sub-species categories (24) have been established, the computer (10) is instructed to identify each sub-species category with a fifth identifier (34). The computer (10) is then instructed to determine, based upon the stored information concerning the given asset, what sub-species category describes the given asset. Once the applicable sub-species category (24) is determined, the computer (10) is instructed to designate the given asset as being described by the applicable sub-species category (24) and the fifth identifier (34) corresponding to the applicable sub-species category is assigned to the given asset.

Referring further to FIG. 2, in one embodiment, the American School species category includes two sub-species categories each having a fifth identifier. These categories include 1850 through 1900, designated by “001” and Hudson River School “002”. To illustrate, the identifier code of a given asset determined to have a Fine Art order category, a Paintings family category, an American through 19^{th} century genus category, an American School species category and a Hudson River School sub-species category would be designated by “001.001.001.001.002”.

In one embodiment, the 19^{th} Century species category includes two sub-species categories each having a fifth identifier. These categories include Metalwork “001” and Stonework “002”. To illustrate, the identifier code of a given asset determined to have a Fine Art order category, a Sculpture family category, an French through 19^{th} century genus category, a 19^{th} century species category and a Metalwork sub-species category would be designated by “001.002.003.001.001”.

In one embodiment, the Seat & Case species category located within either the American through 19^{th} century, English through 19^{th} century, or French through 19^{th} century genus categories each include one sub-species category having a fifth identifier. This category includes 1750 through 1800, designated by “001” and Hudson River School “002”. To illustrate, the identifier code of a given asset determined to have a Decorative Art order category, a Furniture family category, an American through 19^{th} century genus category, a Seat & Case species category and a 1750 through 1800 sub-species category would be designated by “002.001.001.001.001”.

The identifier code assigned to a given asset may be compiled by a database for storage, and/or used to conduct comparisons between the given asset and other assets having the same identifier code. This is accomplished using valuation information that may be stored in the database. Valuation information pertaining to assets having the same identifier code as the given asset may be cross referenced and compared to determine potential variation of its fair market value. Asset information may be transmitted through local or wide area networks or the internet so that it may be readily available anywhere.

### Methods of Classifying Tangible Assets

Referring to the flowchart of FIG. 4, the present invention may also be described as a method for classifying tangible assets. FIG. 4 illustrates an embodiment of the tangible asset classification process of the present invention.

The present invention allows a given asset to be classified by following a few simple steps. A database (12) may be used or accessed by the present invention to allow the storage of information used to classify each asset. The term “database” is used throughout this document to describe anything used to collect and/or organize data. This includes, but is not limited to, a computer, card catalog, hard copy file, electronic file, email storage device, and/or electronic memory devices.

### Order Categories

First, one or more order categories (16) are established within the database. Second, each order category is identified with a first identifier (26). Third, it is determined which of the order categories (16) best describes the asset to be classified (the given asset). Fourth, the given asset is designated within the database as being described by an applicable order category (16). Fifth, the first identifier (26) corresponding to the applicable order category (16) is assigned to the given asset, as described below.

Referring back to FIG. 2, in one embodiment of the present invention, the order categories are Fine Art, Decorative Art, Antiquities, Other Discrete Disciplines, and Collectibles. In this embodiment, “001” is used as the first identifier for the Fine Art order category, “002” is used as the first identifier for the Decorative Art category, “003” is used as the first identifier for the Antiquities category, “004” is used as the first identifier for the Other Discrete Disciplines category, and “005” is used as the first identifier for the Collectibles category.

### Family Categories

In one embodiment, one or more family categories (18) may then be established such that the given asset may be further classified. Once Family categories have been established, each family category is identified with a second identifier (28). It is then determined, based upon stored information concerning the given asset, what family category (18) describes the given asset. Once the applicable family category is determined, the given asset is designated as being described by the applicable family category. The second identifier (28) corresponding to the applicable family category may then be assigned to the given asset.

In one embodiment, the Fine Art order category includes four family categories each having a second identifier. In one embodiment, these categories include Paintings having a second identifier of “001”, Sculpture “002”, Works on Paper “003”, and Tapestries “004”. To illustrate, the identifier code of a given asset determined to have a Fine Art order category and a Tapestries family category would be designated by first and second identifiers of “001.004”.

In one embodiment, the Decorative Art order category includes five family categories each having a second identifier. These categories include Furniture “001”, Decorations “002”, Couture “003”, Ephemera “004”, and Textiles “005”. To illustrate, the identifier code of a given asset determined to have a Decorative Art order category and a Textiles family category would be designated by “002.005”.

In one embodiment, the Antiquities order category includes seven family categories each having a second identifier. These categories include Ancient Near East “001”, Egyptian “002”, Etruscan, Roman “003”, Early Church “004”, Greek & Hellenistic “005”, Pre-Columbian “006”, and Pre-History “007”. To illustrate, the identifier code of a given asset determined to have an Antiquities order category and an Egyptian family category would be designated by “003.002”.

In one embodiment, the Other Discrete Disciplines order category includes nine family categories each having a second identifier. These categories include Arms & Armor “001”, Asian Art “002”, Books, Bindings, Manuscripts, Signatures, & Maps “003”, Carpets “004”, Clocks, Timepieces and Scientific Instruments “005”, Contemporary Forms in Media & Action “006”, Islamic Art “007”, Judaica “008”, and Tribal Art “009”. To illustrate, the identifier code of a given asset determined to have an Other Discrete Disciplines order category and an Carpets family category would be designated by “004.004”.

In one embodiment, the Collectibles order category includes eight family categories each having a second identifier. These categories include Animation & Comic Art “001”, Coins “002”, Geophysical & Mineral “003”, Sports Memorabilia “004”, Stamps“005”, Toys “006”, and Vintage Cars “007”, and Wines “008”. To illustrate, the identifier code of a given asset determined to have a Collectibles order category and a Wines family category would be designated by “005.008”.

### Genus Categories

In one embodiment, one or more genus categories (20) may then be established such that the given asset may be further classified. Once genus categories have been established, each genus category is identified with a third identifier (30). It is then determined, based upon the stored information concerning the given asset, what genus category (20) describes the given asset. Once the applicable genus category is determined, the given asset is designated as being described by the applicable genus category. The third identifier (30) corresponding to the applicable genus category (20), may then be assigned to the given asset.

Referring further to FIG. 2, in one embodiment, the Paintings family category includes twelve genus categories each having a third identifier. These categories include American through 19^{th} century “001” English through 19^{th} century “002”, French through 19^{th} century “003”, Other Continental through 19^{th} century “004”, Contemporary “005”, Modernist 20^{th} century Masterworks “006”, Illuminations & Incunabula “007”, Latin America “008”, Mannerist “009”, Medieval “010”, Old Master “011”, and Renaissance “012”. To illustrate, the identifier code of a given asset determined to have a Fine Art order category, a Paintings family category, and a Mannerist genus category would be designated by “001.001.009”.

In one embodiment, the Sculpture family category includes nine genus categories each having a third identifier. These categories include American through 19^{th} century “001”, English through 19^{th} century “002”, French through 19^{th} century “003”, Other Continental through 19^{th} century “004”, Contemporary “005”, Modernist 20^{th} century Masterworks “006”, Late Roman, Gothic & Medieval “007”, Renaissance “008”, and Garden Sculpture “009”. To illustrate, the identifier code of a given asset determined to have a Fine Art order category, a Sculpture family category, and a Garden Sculpture genus category would be designated by “001.002.009”.

In one embodiment, the Works on Paper family category includes six genus categories each having a third identifier. These categories include Drawings “001”, Watercolors “002”, Photographs “003”, The other print media “004”, Contemporary “005”, and Modernist 20^{th} century Masterworks “006”. To illustrate, the identifier code of a given asset determined to have a Fine Art order category, a Works on Paper family category, and a photographs genus category would be designated by first, second, and third identifiers of “001.003.003”.

In one embodiment, the Furniture family category within the Decorative Art order category includes five genus categories each having a third identifier. These categories include American through 19^{th} century “001”, English through 19^{th} century “002”, French through 19^{th} century “003”, Other Continental through 19^{th} century “004”, and Modernist 20^{th} century Masterworks “005”. To illustrate, the identifier code of a given asset determined to have a Decorative Art order category, a Furniture family category, and a Other Continental through 19^{th} century genus category would be designated by “002.001.004”.

In one embodiment, the Decorations family category within the Decorative Art order category includes five genus categories each having a third identifier. These categories include American through 19^{th} century “001”, English through 19^{th} century “002”, French through 19^{th} century “003”, Other Continental through 19^{th} century “004”, and Modernist 20^{th} century Masterworks “005”. To illustrate, the identifier code of a given asset determined to have a Decorative Art order category, a Decorations family category, and an Other Continental through 19^{th} century genus category would be designated by “002.002.004”.

In one embodiment, the Couture family category within the Decorative Art order category includes three genus categories each having a third identifier. These categories include Costumes “001”, Accessories “002”, and Jewelry: Precious and Other “003”. To illustrate, the identifier code of a given asset determined to have a Decorative Art order category, a Couture family category, and a Costumes genus category would be designated by “002.003.001”.

In one embodiment, the Ancient Near East, Egyptian, Etruscan/Roman, Early Church or Greek & Hellenistic family categories within the Antiquities order category include three genus categories each having a third identifier. These categories include Fine Art “001”, Coinage “002”, and Articles of Daily Life “003”. To illustrate, the identifier code of a given asset determined to have an Antiquities order category, an Egyptian family category, and a Fine Art genus category would be designated by “003.002.001”.

In one embodiment, the Pre-Columbian family category within the Antiquities order category include two genus categories each having a third identifier. These categories include Fine Art “001” and Articles of Daily Life “002”. To illustrate, the identifier code of a given asset determined to have an Antiquities order category, a Pre-Columbian family category, and a Fine Art genus category would be designated by “003.006.001”.

In one embodiment, the Asian Art family category within the Other Discrete Disciplines order category includes five genus categories each having a third identifier. These categories include Chinese “001”, Japanese “002”, Korean “003”, Indian “004”, and Central & Southeast Asian “005”. To illustrate, the identifier code of a given asset determined to have a Decorative Art order category, a Couture family category, and a Costumes genus category would be designated by “002.003.001”.

In one embodiment, the Tribal Art family category within the Other Discrete Disciplines order category includes three genus categories each having a third identifier. These categories include American Indian Art “001”, African Art “002”, and Oceanic Art “003”. To illustrate, the identifier code of a given asset determined to have an Other Discrete Disciplines order category, a Tribal Art family category, and a African Art genus category would be designated by “004.008.002”.

### Species Categories

In one embodiment, one or more species categories (22) may then be established such that the given asset may be further classified. Once species categories (22) have been established, each species category is identified with a fourth identifier (32). It is then determined, based upon the stored information concerning the given asset, what species category (22) describes the given asset. Once the applicable species category is determined, the given asset is designated as being described by the applicable species category. The fourth identifier (32) corresponding to the applicable species category (22) may then be assigned to the given asset.

In one embodiment, the American through 19^{th} century genus category having a Paintings family category includes three species categories each having a fourth identifier. These categories include American School “001”, Itinerant Painters “002”, and Impressionists “003”. To illustrate, the identifier code of a given asset determined to have a Fine Art order category, a Paintings family category, an American through 19^{th} century genus category, and an American School species category would be designated by “001.001.001.001”.

In one embodiment, the English through 19^{th} century genus category having a Paintings family category includes one species category having a fourth identifier. This category includes Victorian “001”. To illustrate, the identifier code of a given asset determined to have a Fine Art order category, a Paintings family category, an English through 19^{th} century genus category, and a Victorian species category would be designated by “001.001.002.001”.

In one embodiment, the French through 19^{th} century genus category having a Paintings family category includes two species categories each having a fourth identifier. These categories include Barbizon School “001” and Impressionists “002”. To illustrate, the identifier code of a given asset determined to have a Fine Art order category, a Paintings family category, a French through 19^{th} century genus category, and an Impressionists species category would be designated by “001.001.003.002”.

In one embodiment, the Modernist 20^{th} century Masterworks genus category having a Paintings family category includes one species category having a fourth identifier. This category includes American “001”. To illustrate, the identifier code of a given asset determined to have a Fine Art order category, a Paintings family category, a Modernist 20^{th} century Masterworks genus category, and an American species category would be designated by “001.001.006.001”.

In one embodiment, the French through 19^{th} century genus category having a Sculpture family category includes one species category having a fourth identifier. This category includes 19^{th} century “001”. To illustrate, the identifier code of a given asset determined to have a Fine Art order category, a Sculpture family category, a French through 19^{th} century genus category, and a 19^{th} century species category would be designated by “001.002.003.001”.

In one embodiment, the Drawings genus category having a Works on Paper family category includes two species categories each having a fourth identifier. These categories include Old Master “001” and Other “002”. To illustrate, the identifier code of a given asset determined to have a Fine Art order category, a Works on Paper family category, Drawings genus category, and an Old Master species category would be designated by “001.003.001.001”.

In one embodiment, the American through 19^{th} century, English through 19^{th} century, and French through 19^{th} century genus categories located within the Furniture family category each include one species category having a fourth identifier. This category includes Seat & Case “001”. To illustrate, the identifier code of a given asset determined to have a Decorative Art order category, a Furniture family category, an American through 19^{th} century genus category, and a Seat & Case species category would be designated by “002.001.001.001”.

In one embodiment, the American through 19^{th} century, English through 19^{th} century, French through 19^{th} century, and Other Continental through 19^{th} century genus categories located within the Decorations family category each include five species categories each having a fourth identifier. These categories include Ceramic “001”, Metalwork: Precious & Other “002”, Stonework “003”, Glass “004” and Wood “005”. To illustrate, the identifier code of a given asset determined to have a Decorative Art order category, a Decorations family category, an American through 19^{th} century genus category, and a Wood species category would be designated by “002.002.001.005”.

### Sub-Species Categories

In one embodiment, one or more sub-species categories (24) may then be established such that the given asset may be further classified. Once sub-species categories have been established, each sub-species category is identified with a fifth identifier (34). It is then determined, based upon the stored information concerning the given asset, what sub-species category (24) describes the given asset. Once the applicable sub-species category is determined, the given asset is designated as being described by the applicable sub-species category (24). The fifth identifier (34) corresponding to the applicable sub-species category may then be assigned to the given asset.

In one embodiment, the American School species category includes two sub-species categories each having a fifth identifier. These categories include 1850 through 1900, designated by “001” and Hudson River School “002”. To illustrate, the identifier code of a given asset determined to have a Fine Art order category, a Paintings family category, an American through 19^{th} Century genus category, an American School species category and a Hudson River School sub-species category would be designated by “001.001.001.001.002”.

In one embodiment, the 19^{th} century species category includes two sub-species categories each having a fifth identifier. These categories include Metalwork “001” and Stonework “002”. To illustrate, the identifier code of a given asset determined to have a Fine Art order category, a Sculpture family category, an French through 19^{th} century genus category, a 19^{th} century species category and a Metalwork sub-species category would be designated by “001.002.003.001.001”.

In one embodiment, the Seat & Case species category located within either the American through 19^{th} century, English through 19^{th} century, or French through 19^{th} century genus categories each include one sub-species category having a fifth identifier. This category includes 1750 through 1800, designated by “001” and Hudson River School “002”. To illustrate, the identifier code of a given asset determined to have a Decorative Art order category, a Furniture family category, an American through 19^{th} century genus category, a Seat & Case species category and a 1750 through 1800 sub-species category would be designated by “002.001.001.001.001”.

In one embodiment, the identifier code assigned to a given asset may be compiled by a database for storage, and/or used to conduct comparisons between the given asset and other assets having the same identifier codes. This is done using valuation information that may be stored in the database. The valuation information may be cross referenced with the identifier code to determine the fair market value of the given asset. Asset information may be transmitted through local or wide area networks or the internet so that information may be readily available anywhere.

In another embodiment, the present invention allows for the classification of tangible assets by following a few simple steps. First, a classification hierarchy (100) having a plurality of categories is provided. Second, at least one given asset is classified by generating output that indicates an applicable order category (16) for the given asset.

The given asset may be further classified by generating output that indicates the applicable family (18), genus, (20), species (22), and sub-species category (24) for the given asset. Each applicable order, family, genus, species, and sub-species category (16, 18, 20, 22 and 24, respectively) may then be assigned first, second, third, fourth, and fifth identifiers (26, 28, 30, 32 and 34, respectively). These assigned identifiers may be combined to form an identifier code which may be used to identify and compare assets of the same classifications.

The present invention provides even greater accuracy to the classification process by providing an additional one hundred separate and distinct classifications that may be combined with the identifier code. Specifically, the present invention provides a scale of 1 to 100 on the left hand side of the classification code, as illustrated in FIG. 2. This additional identifier may be combined with the first, second, third, fourth and fifth identifiers (26, 28, 30, 32 and 34, respectively) of the identifier code to provide further classification of the given asset. In one embodiment, the identifier code of a given asset determined to have a Fine Art order category (16), a Sculpture family category (18), and a Garden Sculpture genus category (20) would be designated by “001.13.002.009”, “13” being the additional identifier in the identifier code.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

I Claim:

1. A method for classifying tangible assets comprising the steps of:
providing a database for storage of information for identifying said assets;
establishing within said database one or more order categories for classifying said assets;
identifying each of said order categories with a first identifier;
determining which of said order categories describes a given asset;
designating within said database said given asset as being classified by said order category which describes said given asset;
assigning said first identifier to said given asset;

2. The method of claim 1, further comprising the following steps:
establishing within said database one or more family categories for classifying said assets;
identifying each of said family categories with a second identifier;
determining which of said family categories describes a given asset;
designating within said database said given asset as being classified by said family category which describes said given asset;
assigning said first identifier and said second identifier to said given asset;
combining said first and said second identifiers to define an identifier code.

3. The method of claim 2, further comprising the following steps:
establishing within said database one or more genus categories for classifying said assets;
identifying each of said genus categories with a third identifier;
determining which of said genus categories describes a given asset;
designating within said database said given asset as being classified by said genus category which describes said given asset;
assigning said first identifier, said second identifier, and said third identifier to said given asset.
combining said first, second, and third identifiers to further define said identifier code.

4. The method of claim 3, further comprising the following steps:
establishing within said database one or more species categories for classifying said given asset;
identifying each of said species categories with a fourth identifier;
determining which of said species categories describes a given asset;
designating within said database said given asset as being classified by said species
category which describes said given asset;
assigning said first identifier, said second identifier, said third identifier, and said fourth identifier to said given asset;
combining said first, second, third, and fourth identifiers to further define said identifier code.

5. The method of claim 4, further comprising the following steps:
establishing within said database one or more sub-species categories for classifying said given asset;
identifying each of said sub-species categories with a fifth identifier;
determining which of said sub-species categories describes a given asset; and
designating within said database said given asset as being classified by said sub-species category which describes said given asset;
assigning said first identifier, said second identifier, said third identifier, said fourth identifier, and said fifth identifier to said given asset;
combining said first, second, third, fourth and fifth identifiers to further define said identifier code.

6. The method of claim 5, wherein said order categories are selected from the group consisting of: fine art, decorative art, antiquities, other discrete disciplines, and collectibles.

7. The method of claim 6, wherein said given asset is of said fine art order category, said family category being selected from the group consisting of: paintings, sculpture, works on paper, and tapestries.

8. The method of claim 6, wherein said given asset is of said decorative art order category, said family category being selected from the group consisting of furniture, decorations, couture, ephemera, and textiles.

9. The method of claim 6, wherein said given asset is of said antiquities order category, said family category being selected from the group consisting of ancient near east, Egyptian, Etruscan/Roman, early church, Greek & Hellenistic, pre-Columbian, and pre-history.

10. The method of claim 6, wherein said given asset is of said other discrete disciplines order category, said family category being selected from the group consisting of arms and armor, Asian art, books, bindings, manuscripts, signatures and maps, carpets, clocks, timepieces and scientific instruments, contemporary forms in media and action, Islamic art, Judaica, and tribal art.

11. The method of claim 6, wherein said given asset is of said collectibles order category, said family category being selected from the group consisting of animation and comic art, coins, geophysical and mineral, sports memorabilia, stamps, toys, vintage cars, and wines.

12. The method of claim 7, wherein said given asset is of said fine art order category and said paintings family category, said genus category being selected from the group consisting of: American through 19^{th} century, English through the 19^{th} century, French through the 19^{th} century, other continental through the 19^{th} century, contemporary, modernist 20^{th} century masterworks, illuminations and incunabula, Latin America, mannerist, medieval, old master, and renaissance.

13. The method of claim 7, wherein said given asset is of said fine art order category and said sculpture family category, said genus category being selected from the group consisting of: American through 19^{th} century, English through the 19^{th} century, French through the 19^{th} century, other continental through the 19^{th} century, contemporary, modernist 20^{th} century masterworks, late roman, gothic and medieval, renaissance, and garden sculpture.

14. The method of claim 7, wherein said given asset is of said fine art order category and said works on paper family category, the genus category being selected from the group consisting of: drawings, watercolors, photographs, the other print media, contemporary, and modernist 20^{th} century masterworks.

15. The method of claim 8, wherein said given asset is of said decorative art order category and said furniture family category, said genus category being selected from the group consisting of: American through 19^{th} century, English through the 19^{th} century, French through the 19^{th} century, other continental through the 19^{th} century, and modernist 20^{th} century masterworks.

16. The method of claim 8, wherein said given asset is of said decorative art order category and said decorations family category, said genus category being selected from the group consisting of: American through 19^{th} century, English through the 19^{th} century, French through the 19^{th} century, other continental through the 19^{th} century, and modernist 20^{th} century masterworks.

17. The method of claim 8, wherein said given asset is of said decorative art order category and said couture family category, said genus category being selected from the group consisting of: costumes, accessories, and precious and other jewelry.

18. The method of claim 9, wherein said given asset is of said antiquities order category and said ancient near east family category, said genus category being selected from the group consisting of: fine art, coinage, and articles of daily life.

19. The method of claim 9, wherein said given asset is of said antiquities order category and said Egyptian family category, said genus category being selected from the group consisting of: fine art and articles of daily life.

20. The method of claim 9, wherein said given asset is of said antiquities order category and said Etruscan/Roman family category, said genus category being selected from the group consisting of: fine art, coinage, and articles of daily life.

21. The method of claim 9, wherein said given asset is of said antiquities order category and said early church family category, said genus category being selected from the group consisting of: fine art, coinage, and articles of daily life.

22. The method of claim 9, wherein said given asset is of said antiquities order category and said Greek & Hellenistic family category, said genus category being selected from the group consisting of: fine art, coinage, and articles of daily life.

23. The method of claim 9, wherein said given asset is of said antiquities order category and said pre-Columbian family category, said genus category being selected from the group consisting of: fine art and articles of daily life.

24. The method of claim 10, wherein said given asset is of said other discrete disciplines order category and said Asian art family category, said genus category being selected from the group consisting of: Chinese, Japanese, Korean, Indian, and central and southeast Asian.

25. The method of claim 10, wherein said given asset is of said other discrete disciplines order category and said tribal art family category; said genus category being selected from the group consisting of: American Indian art, African art, and oceanic art.

26. The method of claim 12, wherein said given asset is of said fine art order category, said paintings family category, and said American through 19^{th} century genus category; said species category being selected from the group consisting of: American school, itinerant painters, and impressionists.

27. The method of claim 12, wherein said given asset is of said fine art order category, said paintings family category, and said English through 19^{th} century genus category; said species category being Victorian.

28. The method of claim 12, wherein said given asset is of said fine art order category, said paintings family category, and said French through 19^{th} century genus category; said species category being selected from the group consisting of: Barbizon school and Impressionists.

29. The method of claim 12, wherein said given asset is of said fine art order category, said paintings family category, and said modernist 20^{th} century masterworks genus category; said species category being American.

30. The method of claim 22, wherein said given asset is of said fine art order category, of said paintings family category, of said American through 19^{th} century genus category, and of said American school species category, said sub-species category selected from the group consisting of: 1850 through 1900 and Hudson River school.

31. The method of claim 13, wherein said given asset is of the fine art order category, of said sculpture family category, and of said French through 19^{th} century genus category, said species category being 19^{th} century.

32. The method of claim 27, wherein said given asset is of the fine art order category, of said sculpture family category, and of said French through 19^{th} century genus category, and of said 19^{th} century species category, said sub-species category selected from the group consisting of: metalwork and stonework.

33. The method of claim 14, wherein said given asset is of the fine art order category, of said works on paper family category, and of said drawings genus category, said species category selected from the group consisting of: old master and other.

34. The method of claim 15, wherein said given asset is of the decorative art order category, of said furniture family category, and of said American through 19^{th} century, said species category being seat & case.

35. The method of claim 15, wherein said given asset is of the decorative art order category, of said furniture family category, and of said English through 19^{th} century genus category, said species category being seat & case.

36. The method of claim 15, wherein said given asset is of the decorative art order category, of said furniture family category, and of said French through 19^{th} century genus category, said species category being seat & case.

37. The method of claim 34, wherein said given asset is of the decorative art order category, of said furniture family category, of said American through 19^{th} century genus category, and of said seat & case species category, said sub-species category being 1750 through 1800.

38. The method of claim 34, wherein said given asset is of the decorative art order category, of said furniture family category, of said English through 19^{th} century genus category, and of said seat & case species category, said sub-species category being 1750 through 1800.

39. The method of claim 34, wherein said given asset is of the decorative art order category, of said furniture family category, of said French through 19^{th} century genus category, and of said seat & case species category, said sub-species category being 1750 through 1800.

40. The method of claim 16, wherein said given asset is of the decorative art order category, of said decorations family category, of said American through 19^{th} century genus category, said sub-species category selected from the group consisting of: ceramic, metalwork: precious or other, stonework, glass, and wood.

41. The method of claim 16, wherein said given asset is of the decorative art order category, of said decorations family category, of said English through 19^{th} century genus category, said sub-species category selected from the group consisting of: ceramic, metalwork: precious or other, stonework, glass, and wood.

42. The method of claim 16, wherein said given asset is of the decorative art order category, of said decorations family category, of said French through 19^{th} century genus category, said sub-species category selected from the group consisting of: ceramic, metalwork: precious or other, stonework, glass, and wood.

43. The method of claim 16, wherein said given asset is of the decorative art order category, of said decorations family category, of said other continental through 19^{th} century genus category, said sub-species category selected from the group consisting of: ceramic, metalwork: precious or other, stonework, glass, and wood.

44. The method of claim 5, further comprising the following steps:
storing valuation information of said given asset within said database; and
valuing said given asset by comparing said valuation information and said classification of said given asset.

45. A computer readable medium comprising a plurality of instructions for classifying tangible assets, which when read by a computer, causes the computer to perform the following steps of:
receiving information regarding a given asset;
storing said information into a database;
establishing within said database one or more order categories for classifying said assets;
identifying each of said order categories with a first identifier;
determining which of said order categories describes a given asset;
designating within said database said given asset as being classified by said order category which describes said given asset;
assigning said first identifier to said given asset.

46. The medium of claim 45, wherein said plurality of instructions causes the computer to perform the additional steps of:
establishing within said database one or more family categories for classifying said assets;
identifying each of said family categories with a second identifier;
determining which of said family categories describes a given asset;
designating within said database said given asset as being classified by said family category which describes said given asset;
assigning said first identifier and said second identifiers to said given asset;
combining said first and second identifiers to define an identifier code.

47. The medium of claim 46, wherein said plurality of instructions causes the computer to perform the additional steps of:
establishing within said database one or more genus categories for classifying said assets;
identifying each of said genus categories with a third identifier;
determining which of said genus categories describes a given asset;
designating within said database said given asset as being classified by said genus category which describes said given asset;
assigning said first identifier, said second identifier, and said third identifier to said given asset;
combining said first, second and third identifiers to further define said identifier code.

48. The medium of claim 47, wherein said plurality of instructions causes the computer to perform the additional steps of:
establishing within said database one or more species categories for classifying said given asset;
identifying each of said species categories with a fourth identifier;
determining which of said species categories describes a given asset;
designating within said database said given asset as being classified by said species category which describes said given asset;
assigning said first identifier, said second identifier, said third identifier, and said fourth identifier to said given asset;
combining said first, second, third and fourth identifiers to further define said identifier code.

49. The medium of claim 48, wherein said plurality of instructions causes the computer to perform the additional steps of:
establishing within said database one or more sub-species categories for classifying said given asset;
identifying each of said sub-species categories with a fifth identifier;
determining which of said sub-species categories describes a given asset; and
designating within said database said given asset as being classified by said sub-species category which describes said given asset;
assigning said first identifier, said second identifier, said third identifier, said fourth identifier, and said fifth identifier to said given asset;
combining said first, second, third, fourth and fifth identifiers to further define said identifier code.

50. The medium of claim 49, wherein said order categories are selected from the group consisting of: fine art, decorative art, antiquities, other discrete disciplines, and collectibles.

51. The medium of claim 50, wherein said given asset is of said fine art order category, said family category being selected from the group consisting of: paintings, sculpture, works on paper, and tapestries.

52. The medium of claim 50, wherein said given asset is of said decorative art order category, said family category being selected from the group consisting of furniture, decorations, couture, ephemera, and textiles.

53. The medium of claim 50, wherein said given asset is of said antiquities order category, said family category being selected from the group consisting of ancient near east, Egyptian, Etruscan/Roman, early church, Greek & Hellenistic, pre-Columbian, and pre-history.

54. The medium of claim 50, wherein said given asset is of said other discrete disciplines order category, said family category being selected from the group consisting of arms and armor, asian art, books, bindings, manuscripts, signatures and maps, carpets, clocks, timepieces and scientific insruments, contemporary forms in media and action, Islamic art, Judaica, and tribal art.

55. The medium of claim 50, wherein said given asset is of said collectibles order category, said family category being selected from the group consisting of animation and comic art, coins, geophysical and mineral, sports memorabilia, stamps, toys, vintage cars, and wines.

56. The medium of claim 51, wherein said given asset is of said fine art order category and said paintings family category, said genus category being selected from the group consisting of: American through 19^{th} century, English through the 19^{th} century, French through the 19^{th} century, other continental through the 19^{th} century, contemporary, modernist 20^{th} century masterworks, illuminations and incunabula, Latin America, mannerist, medieval, old master, and renaissance.

57. The medium of claim 51, wherein said given asset is of said fine art order category and said sculpture family category, said genus category being selected from the group consisting of: American through 19^{th} century, English through the 19^{th} century, French through the 19^{th} century, other continental through the 19^{th} century, contemporary, modernist 20^{th} century masterworks, late Roman, gothic and medieval, renaissance, and garden sculpture.

58. The medium of claim 51, wherein said given asset is of said fine art order category and said works on paper family category, the genus category being selected from the group consisting of: drawings, watercolors, photographs, the other print media, contemporary, and modernist 20^{th} century masterworks.

59. The medium of claim 52, wherein said given asset is of said decorative art order category and said furniture family category, said genus category being selected from the group consisting of: American through 19^{th} century, English through the 19^{th} century, French through the 19^{th} century, other continental through the 19^{th} century, and modernist 20^{th} century masterworks.

60. The medium of claim 52, wherein said given asset is of said decorative art order category and said decorations family category, said genus category being selected from the group consisting of: American through 19^{th} century, English through the 19^{th} century, French through the 19^{th} century, other continental through the 19^{th} century, and modernist 20^{th} century masterworks.

61. The medium of claim 52, wherein said given asset is of said decorative art order category and said couture family category, said genus category being selected from the group consisting of: costumes, accessories, and precious and other jewelry.

62. The medium of claim 53, wherein said given asset is of said antiquities order category and said ancient near east family category, said genus category being selected from the group consisting of: fine art, coinage, and articles of daily life.

63. The medium of claim 53, wherein said given asset is of said antiquities order category and said Egyptian family category, said genus category being selected from the group consisting of: fine art and articles of daily life.

64. The medium of claim 53, wherein said given asset is of said antiquities order category and said Etruscan/Roman family category, said genus category being selected from the group consisting of: fine art, coinage, and articles of daily life.

65. The medium of claim 53, wherein said given asset is of said antiquities order category and said early church family category, said genus category being selected from the group consisting of: fine art, coinage, and articles of daily life.

66. The medium of claim 53, wherein said given asset is of said antiquities order category and said Greek & Hellenistic family category, said genus category being selected from the group consisting of: fine art, coinage, and articles of daily life.

67. The medium of claim 53, wherein said given asset is of said antiquities order category and said pre-Columbian family category, said genus category being selected from the group consisting of: fine art and articles of daily life.

68. The medium of claim 54, wherein said given asset is of said other discrete disciplines order category and said Asian art family category, said genus category being selected from the group consisting of: Chinese, Japanese, Korean, Indian, and central and southeast Asian.

69. The medium of claim 54, wherein said given asset is of said other discrete disciplines order category and said tribal art family category; said genus category being selected from the group consisting of: American Indian art, African art, and oceanic art.

70. The medium of claim 56, wherein said given asset is of said fine art order category, said paintings family category, and said American through 19^{th} century genus category; said species category being selected from the group consisting of: American school, itinerant painters, and Impressionists.

71. The medium of claim 56, wherein said given asset is of said fine art order category, said paintings family category, and said English through 19^{th} century genus category; said species category being Victorian.

72. The medium of claim 56, wherein said given asset is of said fine art order category, said paintings family category, and said French through 19^{th} century genus category; said species category being selected from the group consisting of: barbizon school and impressionists.

73. The medium of claim 56, wherein said given asset is of said fine art order category, said paintings family category, and said modernist 20^{th} century masterworks genus category; said species category being American.

74. The medium of claim 52, wherein said given asset is of said fine art order category, of said paintings family category, of said American through 19^{th} century genus category, and of said American School species category, said sub-species category selected from the group consisting of: 1850 through 1900 and Hudson River School.

75. The medium of claim 57, wherein said given asset is of the fine art order category, of said sculpture family category, and of said French through 19^{th} genus category, said species category being 19^{th} century.

76. The medium of claim 75, wherein said given asset is of the fine art order category, of said sculpture family category, of said French through 19^{th} genus category, and of said 19^{th} century species category, said sub-species category selected from the group consisting of: metalwork and stonework.

77. The medium of claim 58, wherein said given asset is of the fine art order category, of said works on paper family category, of said drawings genus category, said species category selected from the group consisting of: old master and other.

78. The medium of claim 59, wherein said given asset is of the decorative art order category, of said furniture family category, of said American through 19^{th} century, English through 19^{th} century or French through 19^{th} genus category, said species category being seat and case.

79. The medium of claim 78, wherein said given asset is of the decorative art order category, of said furniture family category, of said American through 19^{th} century genus category, and of said seat and case species category, said sub-species category being 1750 through 1800.

80. The medium of claim 78, wherein said given asset is of the decorative art order category, of said furniture family category, of said English through 19^{th} century genus category, and of said seat and case species category, said sub-species category being 1750 through 1800.

81. The medium of claim 78, wherein said given asset is of the decorative art order category, of said furniture family category, of said French through 19^{th} century genus category, and of said seat and case species category, said sub-species category being 1750 through 1800.

82. The medium of claim 60, wherein said given asset is of the decorative art order category, of said decorations family category, American through 19^{th} century genus category, said sub-species category selected from the group consisting of: ceramic, metalwork: precious or other, stonework, glass, and wood.

83. The medium of claim 60, wherein said given asset is of the decorative art order category, of said decorations family category, English through 19^{th} century genus category, said sub-species category selected from the group consisting of: ceramic, metalwork: precious or other, stonework, glass, and wood.

84. The medium of claim 60, wherein said given asset is of the decorative art order category, of said decorations family category, French through 19^{th} century genus category, said sub-species category selected from the group consisting of: ceramic, metalwork: precious or other, stonework, glass, and wood.

85. The medium of claim 60, wherein said given asset is of the decorative art order category, of said decorations family category, Other Continental through 19^{th} century genus category, said sub-species category selected from the group consisting of: ceramic, metalwork: precious or other, stonework, glass, and wood.

86. The medium of claim 49, wherein said plurality of instructions causes the computer to perform the additional steps of:
storing valuation information of said given asset within said database; and
valuing said given asset by comparing said valuation information and said classification of said given asset.

87. A computer system for classifying tangible assets comprising:
a database for storing asset information; and
a processing unit for establishing one or more order categories for classifying said assets, for identifying a first identifier for each of said order categories, for determining which order category describes a given asset, and for designating said given asset as being classified by said order category that describes said given asset, said processing unit coupled to said database.

88. The computer system of claim 87, further comprising a processing unit for establishing one or more family categories for classifying said assets, for identifying a second identifier for each of said family categories, for determining which family category describes a given asset, for designating said given asset as being classified by said family category that describes said given asset, for assigning said first and said second identifiers to said given asset and for combining said first and second identifiers to define said identifier code, said processing unit coupled to said database.

89. The computer system of claim 88, further comprising a processing unit for establishing one or more genus categories for classifying said assets, for identifying a third identifier for each of said genus categories, for determining which genus category describes a given asset, for designating said given asset as being classified by said genus category that describes said given asset, for assigning said first identifier, said second identifier, and said third identifier to said given asset and for combining said first, second and third identifiers to further define said identifier code said processing unit coupled to said database.

90. The computer system of claim 89, further comprising a processing unit for establishing one or more species categories for classifying said assets, for identifying a fourth identifier for each of said species categories, for determining which species category describes a given asset, for designating said given asset as being classified by said species category that describes said given asset, for assigning said first identifier, said second identifier, said third identifier, and said fourth identifier to said given asset and for combining said first, second, third and fourth identifiers to further define said identifier code said processing unit coupled to said database.

91. The computer system of claim 90, further comprising a processing unit for establishing one or more sub-species categories for classifying said assets, for identifying a fifth identifier for each of said sub-species categories, for determining which sub-species category describes a given asset, for designating said given asset as being classified by said sub-species category that describes said given asset, for assigning said first identifier, said second identifier, said third identifier, said fourth identifier, and said fifth identifier to said given asset and for combining said first, second, third, fourth and fifth identifiers to further define said identifier code, said processing unit coupled to said database.

92. The system of claim 87, further comprising an input device for receiving valuation information, said processing unit capable of comparing said valuation information to said classification of said given asset such that the value of said given asset may be determined.

93. A method for classifying tangible assets comprising the steps of:
providing a classification hierarchy that includes a plurality of categories;
classifying at least one given asset by generating classification output that indicates the order category of said given asset.

94. The method of claim 93 further comprising the following step:
classifying said given asset by generating classification output that indicates the family category for said given asset.

95. The method of claim 94 further comprising the following step:
classifying said given asset by generating classification output that indicates the genus category for said given asset.

96. The method of claim 95 further comprising the following step:
classifying said given asset by generating classification output that indicates the species category for said given asset.

97. The method of claim 96 further comprising the following step:
classifying said given asset by generating classification output that indicates the subspecies category for said given asset.

98. The method of claim 97 further comprising the step of:
assigning a first, second, third, fourth and fifth identifier to said order, family, genus, species, and sub-species categories respectively.

99. The method of claim 98 further comprising the following steps:
combining said first, second, third, fourth, and fifth identifiers to define an identifier code.
